(19) United States
(12) Patent Application Publication
(10) Pub. No.: US 2006/0250939 A1
(43) Pub. Date: Nov. 9, 2006

(54) Optimal timing and frequency acquisition for OFDM systems

(76) Inventors: Michael Mao Wang, San Diego, CA (US); Alok Kumar Gupta, Encinitas, CA (US)

Correspondence Address: QUALCOMM INCORPORATED, 5775 MOREHOUSE DR., SAN DIEGO, CA, 92121, US

(21) Appl. No.: 11/390,623

(22) Filed: Mar. 27, 2006

Related U.S. Application Data
(60) Provisional application No. 60/666,277, filed on Mar. 28, 2005.

(51) Int. Cl. H04J 11/00

(52) U.S. Cl. 370/208

(57) ABSTRACT

Systems and methods are provided for processing Time Domain Multiplexing Pilot symbols by employing matched filtering components to process delayed correlator outputs as opposed to applying a fixed threshold directly to the delayed correlator outputs. In an embodiment, a method for timing acquisition in a wireless network is provided. The method includes filtering a correlation output of a TDM pilot via an edge template and employing the correlation output to determine timing or frequency in a wireless network.

### CROSS REFERENCE TO RELATED APPLICATION

This application claims the benefit of U.S. Provisional Patent Application Ser. No. 60/666,277 filed on Mar. 28, 2005, entitled “Optimal timing and frequency acquisition” the entirety of which is incorporated herein by reference.

### BACKGROUND

I. Field

The subject technology relates generally to communications systems and methods, and more particularly to systems and methods that determine timing and frequency information in an OFDM system by applying matched filtering functions to detect received pilot symbols.

II. Background

An air interface specification defines FLO (Forward Link Only) technology that has been developed by an industry-led group of wireless providers. The basic signal unit for FLO™ transmission is an Orthogonal Frequency Division Multiplexing (OFDM) symbol that consists of 4642 time-domain base-band samples called OFDM chips. Among these OFDM chips are 4096 data chips. The data chips are cyclically extended on each side, with 529 cyclically extended chips preceding the data portion and 17 following the data portion. To reduce the OFDM signal's out-band energy, the first 17 chips and the last 17 chips in an OFDM symbol have a raised cosine envelope. The first 17 chips of an OFDM symbol overlap with the last 17 chips of the OFDM symbol that precede them. As a result, the time duration of each OFDM symbol is 4625 chips long.

Before transmission, FLO data is generally organized into super frames. Each super frame has one second duration. A super frame generally consists of 1200 symbols (or variable number of OFDM symbols based on the bandwidth being used) that are OFDM modulated with 4096 sub-carriers. Among the 1200 OFDM symbols in a super frame, there are: Two TDM pilot symbols (TDM1, TDM2); One wide-area and 1 local identification channel (WIC and LIC) symbols; Fourteen OIS channel symbols, including four Transitional Pilot Channel (TPC) symbols; A variable number of two, six, 10, or 14 PPC symbols for assisting with position location; and Four data frames.

Time Division Multiplexing (TDM) Pilot Symbol 1 (TDM1) is the first OFDM symbol of each super frame, where TDM1 is periodic and has a 128 OFDM chip period. The receiver uses TDM1 for frame synchronization and initial time (course timing) and frequency acquisition. Following TDM1, are two symbols that carry the wide-area and local IDs, respectively. The receiver uses this information to perform proper descrambling operations utilizing the corresponding PN sequences. Time division Multiplexing pilot Symbol 2 (TDM2) follows the wide-area and local ID symbols, where TDM2 is periodic, having a 2048 OFDM chip period, and contains two and a fraction periods. The receiver uses TDM2 when determining accurate timing for demodulation.

Following TDM2 are: One wide-area TPC (WTPC) symbol; Five wide-area OIS symbols; Another WTPC; One local TPC (LTPC) symbol; Five local OIS symbols; Another LTPC; and Four data frames follow the first 18 OFDM symbols described above. A data frame is subdivided into a wide-area data portion and a local data portion. The wide-area Data is pre-pended and appended with the wide-area TPC—one on each end. This arrangement is also used for the local data portion. One important aspect is the initial processing of super frame information in order to determine such aspects as the start of a new super frame such that further frame information can be synchronized and determined there from.

There are several problems that are related with conventional pure delayed autocorrelation based timing and frequency acquisition systems. One problem relates to the fact that timing acquisition uses a fixed threshold directly on the delayed correlation estimate to detect a rising and trailing edge of a delayed autocorrelation estimate calculated directly from a hypothesized TDM Pilot 1 waveform. This method suffers from the sensitivity to the variation of noise/interference level such as caused by a tone jammer. There are other variations of the pure autocorrelation based methods which have similar limitations. Another problem is that current frequency acquisition algorithms update a frequency offset during the coarse timing acquisition period which results in at least two drawbacks: First, it impairs the correlation used for timing acquisition; second, it provides degraded frequency estimate which may cause acquisition failure. Another problem relates to large detection delays of conventional systems, resulting in the potential missed processing of the next OFDM symbol.

### SUMMARY

The following presents a simplified summary of various embodiments in order to provide a basic understanding of some aspects of the embodiments. This summary is not an extensive overview. It is not intended to identify key/critical elements or to delineate the scope of the embodiments disclosed herein. Its sole purpose is to present some concepts in a simplified form as a prelude to the more detailed description that is presented later.

Systems and methods are provided for determining timing and frequency information in an Orthogonal Frequency Division Multiplexing (OFDM) system. A matched filter is employed to process a delayed correlator output signal in a wireless receiver with a correlation function. Output from the matched filter can be monitored and processed according to several methods to determine timing and frequency information from received pilot OFDM symbols. In an aspect, an edge template is employed as the correlation function and applied to the delayed correlator output in the matched filter. A peak detector monitors output from the filter and initiates timing and frequency calculations in the receiver based on the highest detected signal peak from the matched filter. If a subsequent peak is detected having a higher signal magnitude, timing and frequency acquisition can be restarted. In this manner, the true start of the frame in which OFDM information is received can be detected more reliably over predetermined threshold methods applied to the delayed correlator output itself since the highest peak has the highest probability of being the start of the frame and thus is not likely to be an indication of system noise. In an aspect, a method for timing acquisition in a wireless network is provided. The method includes filtering a correlation output of a TDM pilot via a correlation function and employing the correlation output to determine timing or frequency in a wireless network.

In another aspect, 1. a function is employed that matches the ideal correlation function of a received TDM Pilot 1 waveform to correlate with estimated correlation data over the entire period of superframe (e.g., one second), where the maximum correlation corresponds the TDM Pilot 1 position. A simplified version is to use an edge template to correlate with the estimated correlation data. When the output of the matched filter exceeds a predetermined threshold, the start of TDM Pilot symbol is detected, where the start of an accumulation process for an automatic frequency control (AFC) for the TDM Pilot symbol period is initiated. During this period, if a larger output is detected, a frequency accumulator can be cleared which restarts the accumulation process. At the end of the period, TDM Pilot 1 detection is declared (therefore the timing is acquired) and the accumulated data is used to calculate a frequency offset and used to update the system frequency in a wireless receiver.

To the accomplishment of the foregoing and related ends, certain illustrative embodiments are described herein in connection with the following description and the annexed drawings. These aspects are indicative of various ways in which the embodiments may be practiced, all of which are intended to be covered.

### BRIEF DESCRIPTION OF THE DRAWINGS

FIG. 1 is a schematic block diagram illustrating timing and frequency processing components for a wireless receiver.

FIG. 2 illustrates an example correlation processing system.

FIG. 3 illustrates an example edge correlation function.

FIG. 4 illustrates an example timing diagram for an edge correlation processing system.

FIG. 5 is illustrates an alternative correlation processing system.

FIG. 6 illustrates an alternative timing diagram for a correlation processing system.

FIG. 7 is a flow diagram illustrating example processing for time domain multiplexing pilot signals.

FIG. 8 is a diagram illustrating an example user device for a wireless system.

FIG. 9 is a diagram illustrating an example base station for a wireless system.

FIG. 10 is a diagram illustrating an example transceiver for a wireless system.

### DETAILED DESCRIPTION

Systems and methods are provided for processing Time Domain Multiplexing Pilot symbols by employing matched filtering components to process delayed correlator outputs as opposed to applying a fixed threshold directly to the delayed correlator outputs. In an embodiment, a method for timing acquisition in a wireless network is provided. The method includes filtering a correlation output of a TDM pilot via an edge template and employing the correlation output to determine timing or frequency in a wireless network. In general, magnitude information derived from the pilot symbols is employed to determine system timing information (sync local receiver clock to transmitter clock) where phase information derived from the pilot symbols is employed to determine system frequency information.

As used in this application, the terms “component,” “network,” “system,” and the like are intended to refer to a computer-related entity, either hardware, a combination of hardware and software, software, or software in execution. For example, a component may be, but is not limited to being, a process running on a processor, a processor, an object, an executable, a thread of execution, a program, and/or a computer. By way of illustration, both an application running on a communications device and the device can be a component. One or more components may reside within a process and/or thread of execution and a component may be localized on one computer and/or distributed between two or more computers. Also, these components can execute from various computer readable media having various data structures stored thereon. The components may communicate over local and/or remote processes such as in accordance with a signal having one or more data packets (e.g., data from one component interacting with another component in a local system, distributed system, and/or across a wired or wireless network such as the Internet).

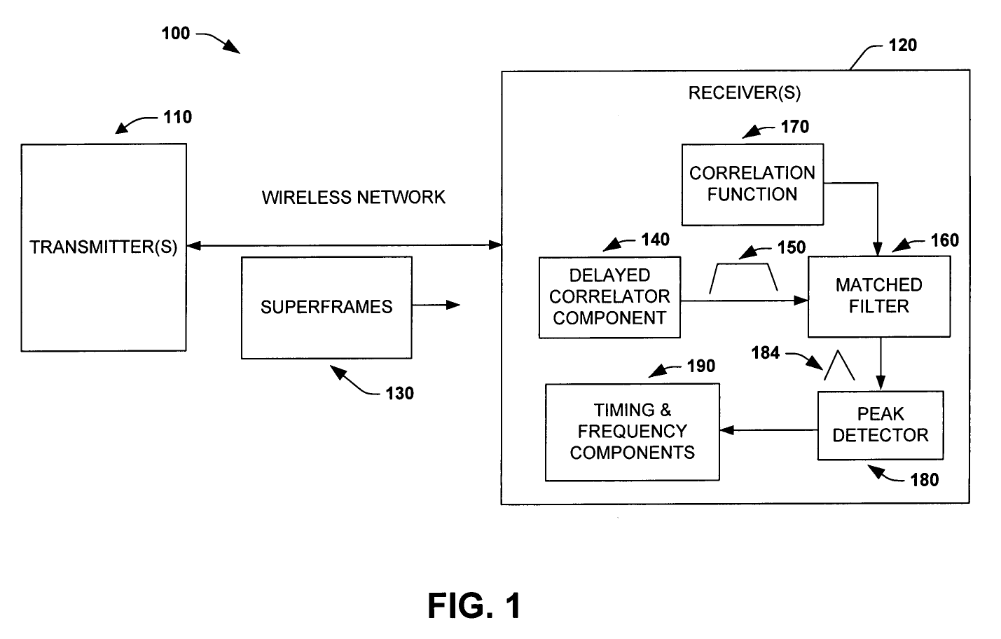

FIG. 1 illustrates timing and frequency processing components for a wireless system 100. The system 100 includes one or more transmitters 110 that communicate across a wireless network to one or more receivers 120. The receivers 120 can include substantially any type of communicating device such as a cell phone, computer, personal assistant, hand held or laptop devices, and so forth. Portions of the receiver 120 are employed to decode and process a super frame 130 and other data such as multimedia data. The super frame 130 is generally transmitted in an Orthogonal Frequency Division Multiplexing (OFDM) network that can also employ forward link only (FLO) protocols for multimedia data transfer. The superframe 130 generally includes a Time Division Multiplexing Pilot 1 symbol (not shown) that is employed for timing and frequency acquisition in the receiver 120. A delayed correlator component 140 in the receiver 120 processes the super frame 130 and generates a ramp output signal 150 when it encounters a TDM1 OFDM symbol, where it is noted that TDM1 and TDM Pilot1 are equivalent terms.

From the ramp output signal 150, a matched filter 160 is employed to process the delayed correlator output signal 150 in the receiver 120 with a correlation function 170. Output from the matched filter 160 can be monitored and processed according to several methods to determine timing and frequency information from received pilot OFDM symbols in the superframe 130. In an aspect, an edge template can employed as the correlation function 170 and applied to the delayed correlator output 150 in the matched filter 160, where the matched filter generally applies a differentiation on the delayed correlator output so that the output has less dependency on the noise/interference level. A peak detector 180 monitors output 184 from the matched filter 160 and initiates timing and frequency calculations in the receiver 120 via components 190 based on the highest detected signal peak from the matched filter 160. If a subsequent peak is detected having a higher signal magnitude at 184, timing and frequency acquisition can be restarted at 190.

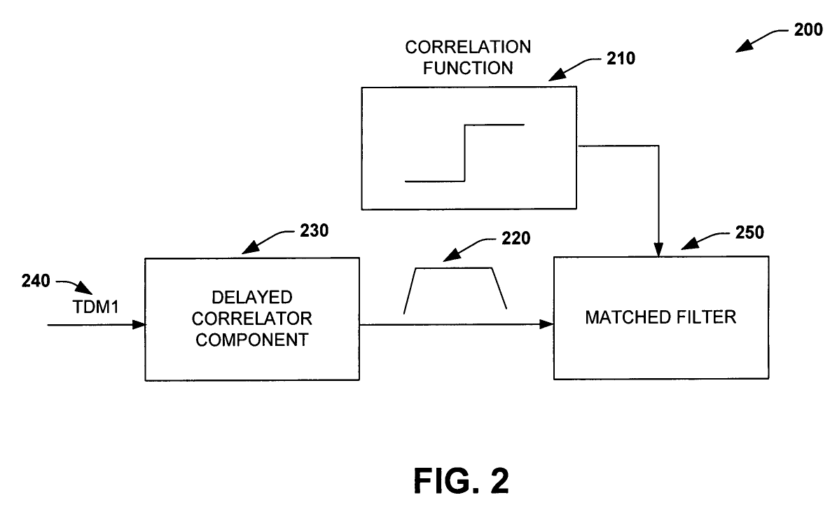

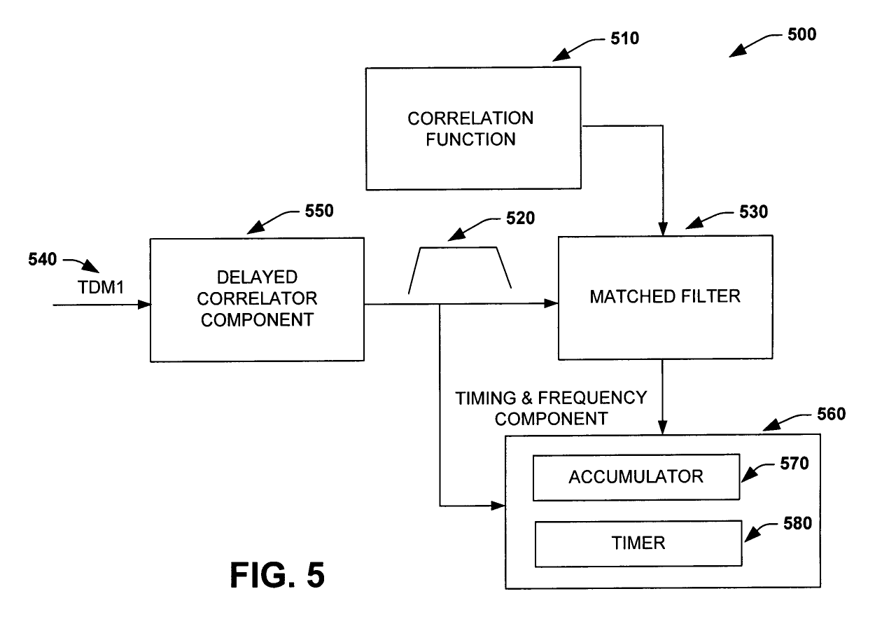

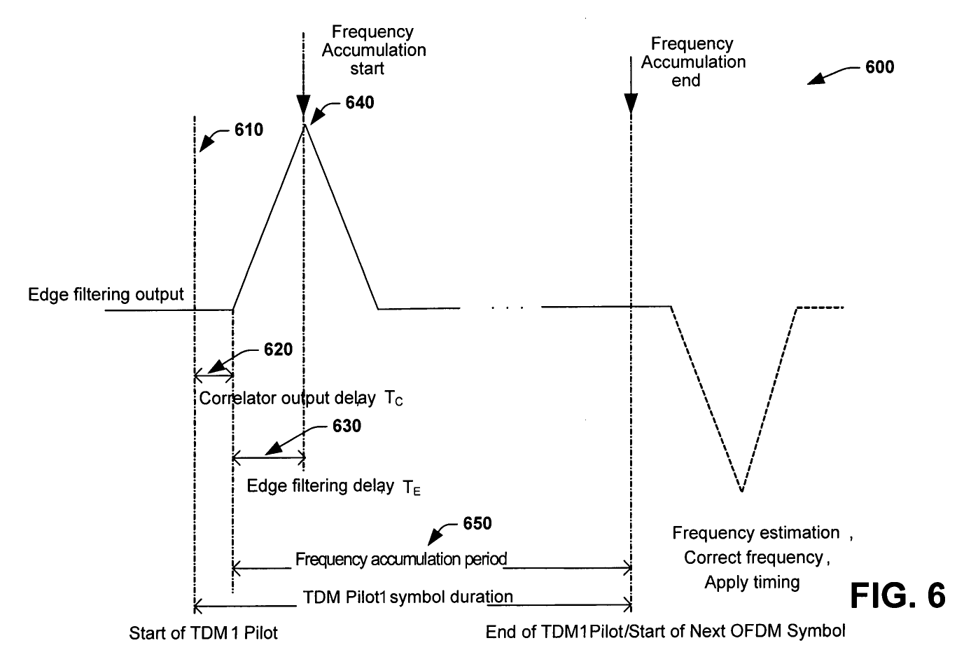

As will be described more detail below, several methods can be employed to process the delayed correlator output 150. In an optimized method, a template can be employed at 170 that matches the ideal delayed correlation function of the TDM Pilot 1 waveform 150 to correlate with the estimated correlation data over the entire period of superframe 130 (e.g., one second) where the maximum correlation corresponds the TDM Pilot 1 position. This method is described with relation to FIGS. 5 and 6. For lower complexity and smaller delays, an alternative edge detection algorithm can be employed as described with respect to FIGS. 2-4. Before proceeding it is noted that the peak detector 180 can employ substantially any method for detecting the highest received output from the matched filter 160. This could employ utilizing known peak detector circuits or employing a variable threshold, where a new threshold is established each time a new highest peak is detected or established. Also, more the one sample can be employed to determine whether or not the highest peak has been obtained such as a sample subset employed to determine the average highest peak. In another aspect, multiple or nested correlations could be performed to detect TDM1. For instance, the output at 184 could be applied to a subsequent correlation function, then subsequently detected, and processed for timing and frequency information. In an aspect, a component is provided for determining timing or frequency data in a wireless network. The component (receiver 120) includes means for analyzing a superframe 130 to determine a delayed output signal (reference numeral 140; means for generating a correlation function (reference numeral 170); and means for filtering the delayed output signal (reference numeral 160) and the correlated function 170 to determine a start of an OFDM packet.

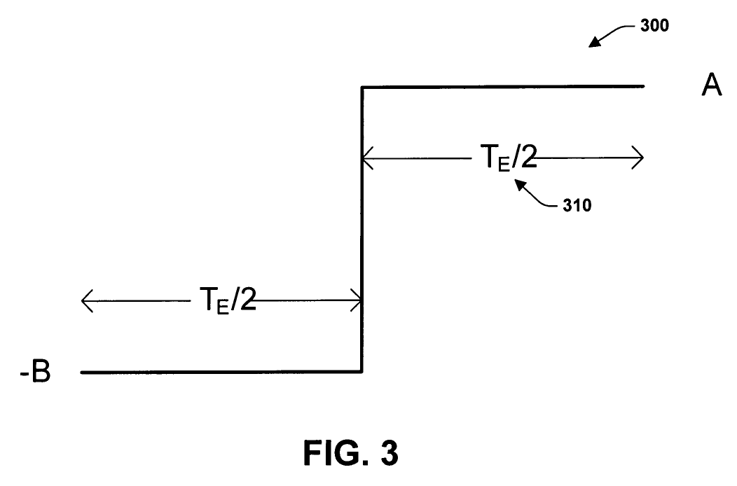

FIG. 2 illustrates an example system 200 and correlation function 210. In a simplified process an edge template 210 is employed that matches the front part of an ideal autocorrelation function 220 for a TDM Pilot 1 symbol 230. Similar to FIG. 1 above, a delayed correlator component 240 generates the auto correlation function 220 from TDM1 230. In an embodiment, the edge template 210 can have length T_{E} (-A -A -A . . . -A B B B B . . . B) that matches the front part of the ideal autocorrelation function, where an example function 300 is shown in FIG. 3, to correlate with estimated correlation data via a matched filter 250 shown in FIG. 2. This operation removes the dependency of the correlator output 230 to the noise/interference level, i.e.,

$$Δ = \vert {\sum }_{k = 0}^{{T}_{E} / 2 - 1} {Bx}_{k} \vert - \vert {\sum }_{k = - {T}_{E} / 2}^{- 1} {Ax}_{k} \vert .$$

When the output of the matched filter 250 of FIG. 2, exceeds a predetermined threshold, the start of TDM Pilot symbol can be detected. This detection then starts the accumulation process of an automatic frequency control (AFC) for the TDM Pilot symbol period. During this period, if a larger output is determined or detected, a clear operation can be performed on an AFC accumulator (not shown) which initiates a re-start of the accumulation process. At the end of the detection period, TDM Pilot 1 detection is declared (therefore the timing is acquired) and the accumulated data is then employed to calculate the frequency offset and used to update the system frequency.

In general, the use of edge template 210 can introduce delay, where the delay can be equal to T_{E}/2 as shown at 310 of FIG. 3, which is about the half of the template length. The length of the edge template 210 of FIG. 2 is generally less or equal to the TDM Pilot 1 symbol duration denoted as Ts. The larger the length of the edge template 210, the better the detection performance is but the longer the delay. To reduce the delay due to the detection of the end boundary of the TDM Pilot symbol 240, an alternative embodiment eliminates the detection of the end boundary of TDM1 and assumes the end boundary of TDM Pilot 1 is Ts seconds away from the start boundary. Therefore, the end boundary of the TDM Pilot 1 or the start of the next OFDM symbol can be detected without delay.

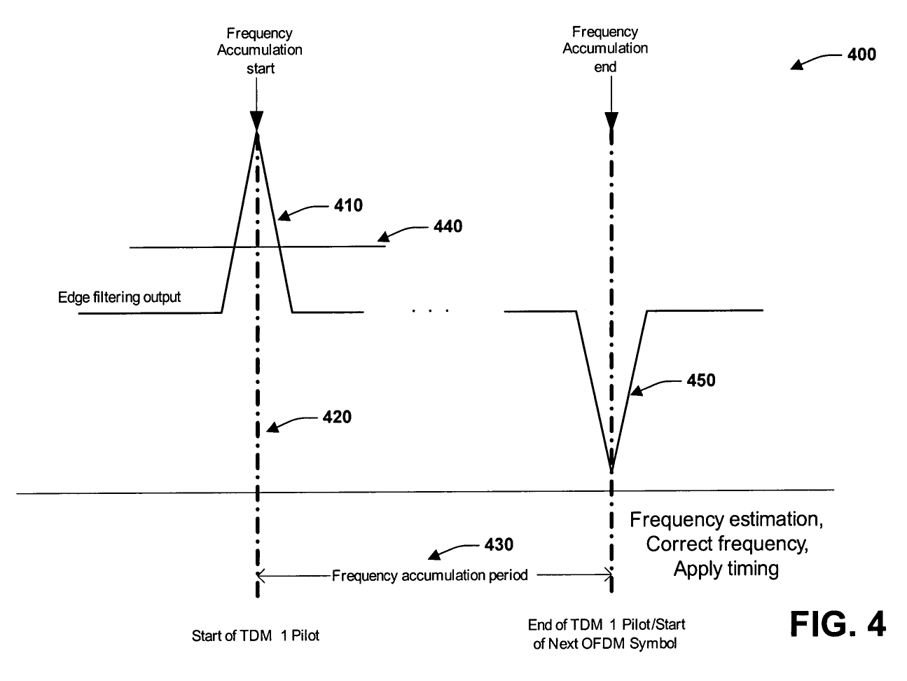

FIG. 4 illustrates an example waveforms 400 that can be detected according to the processes described above with respect to FIGS. 2 and 3. As shown, a triangular signal 410 is detected at the output of the matched filter described above. The signal 410 starts a frequency accumulation process at 420 and continues during a frequency accumulation period 430. As noted above, a threshold 440 can be applied to the signal 410 to detect the frequency accumulation start period 420. If a subsequent signal is detected that is higher than the previous threshold or a new peak is established, the accumulation can be reset and the acquisition period 430 can be restarted. As shown, a trailing edge could be detected at 450, however to mitigate delays, the edge 450 can be determined from known parameters of a superframe such as time spacing for the next TDM 1 and that it would be received a know time period from the signal 410 start (e.g., 1 second).

FIGS. 5 and 6 illustrate an alternative embodiment where correlations are determined over the period of a superframe. Similar to FIG. 2 above, a system 500 includes a correlation function 510 and a delayed correlator output 520 that are applied to a matched filter 530. As shown, a TDM1 pilot 540 is processed by a delayed correlator component 550 to generate the delayed correlator output 520 which is supplied to the matched filter 530. At 560, a timing and frequency component employs a frequency accumulator 570 (or accumulator) and a timer 580 to determine timing and frequency estimates for a wireless receiver, where FIG. 6 illustrates an example timing diagram 600 for the system 500. A template is employed at 510 to filter the correlation output of the TDM Pilot 1 540. The delayed correlator output 530 is buffered with length of T_{E}/2 (as shown in FIG. 3) via accumulator 570. When the matched filter 530 output exceeds a predetermined threshold, the accumulator 570 start to accumulate the correlator output 520 and the timer 580 starts timing. If the matched filter 530 output exceeds the previous detected value, both the accumulator 570 and timer 580 are reset and restart. When the timer 580 finally expires, the frequency accumulator 570 stops. The frequency estimate is then calculated based on the value in the accumulator 570 and applied to correct the frequency offset in the wireless receiver. The OFDM symbol boundary can also be determined for the next OFDM symbol processing.

Referring briefly to FIG. 6, reference numeral 610 indicates the start of a TDM1 pilot signal. At 620, a correlator output delay T_{C} is illustrated and an edge filtering delay T_{E} is illustrated at 630. At 640, frequency accumulation start is indicated and continues during a frequency acquisition period which is generally the period of the TDM1 pilot symbol. As noted previous, the embodiments disclosed herein can employ matched edge detectors which sample the output of TDM Pilot 1 waveform correlation data instead of applying a fixed threshold directly on the TDM Pilot 1 waveform correlation data, thus providing more noise and interference variation resistance and improved accuracy. This improved timing accuracy also improves the frequency acquisition accuracy. In an aspect, the AFC loop in the receiver can be opened (accumulation only, no correction) during TDM Pilot I detection period. This mitigates disturbances to the correlation estimation and greatly improves the frequency estimation accuracy.

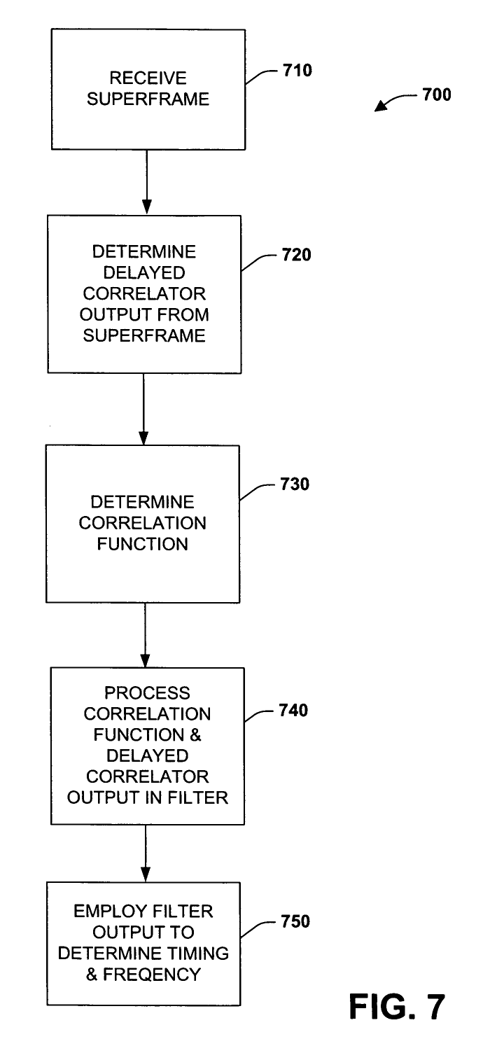

FIG. 7 illustrates an example process 700 for determining frequency and timing from time division multiplexing pilot signals. While, for purposes of simplicity of explanation, the methodology is shown and described as a series or number of acts, it is to be understood and appreciated that the processes described herein are not limited by the order of acts, as some acts may occur in different orders and/or concurrently with other acts from that shown and described herein. For example, those skilled in the art will understand and appreciate that a methodology could alternatively be represented as a series of interrelated states or events, such as in a state diagram. Moreover, not all illustrated acts may be required to implement a methodology in accordance with the subject methodologies disclosed herein.

Proceeding to 710, a superframe is received at a wireless receiver. The superframe could include substantially any type of OFDM data packet that employs a TDM1 pilot symbol to allow timing and frequency corrections at the receiver. At 720, a delayed correlator output is determined from the superframe of 710. As noted above, such output is a general rectangular structure. In previous systems, such delayed correlator output was compared directly to a threshold which suffered from noise problems at or near the threshold. In the embodiments disclosed herein a correlation function is determined at 730, where the correlation function and the delayed correlator output are applied to a filter at 740. Output from the filter may appear as a triangular waveform that can be employed for peak detection to determine the start of TDM1. Such peak detection could include applying a threshold to the filter output however peak detection circuits or components may also be employed. At 750, after the detected start of TDM1, the filter output is employed to synchronize timing with the transmitter and to determine frequency considerations for the receiver. Such frequency can be determined between the start of a given TDM1 and a subsequent TDM1 in another received superframe. As noted above, knowledge of superframe structure can be employed to mitigate delays in processing at the end of a superframe period by performing known timing and frequency calculations from the start of the detected TDM1 as determined from the filter output.

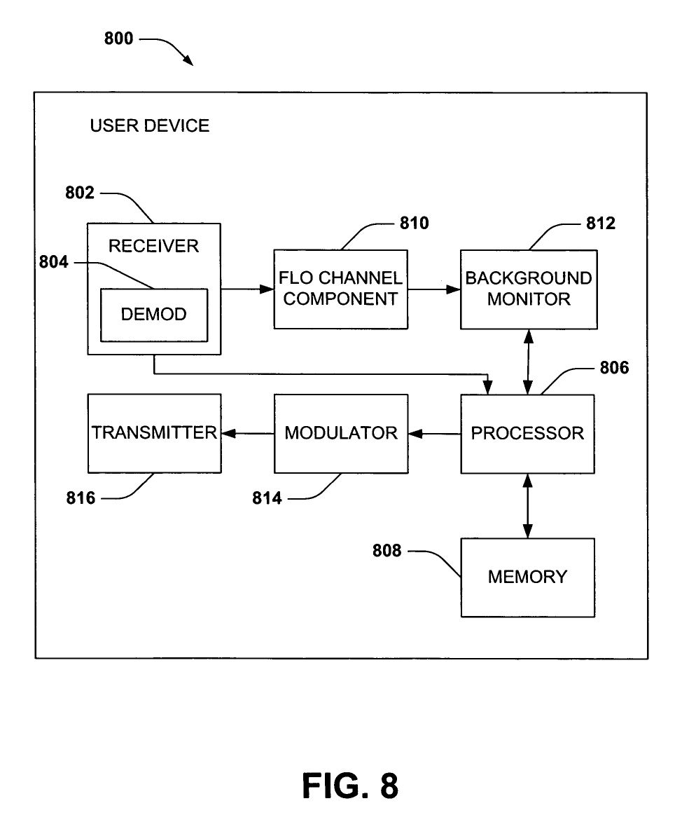

FIG. 8 is an illustration of a user device 800 that is employed in a wireless communication environment, in accordance with one or more aspects set forth herein. User device 800 comprises a receiver 802 that receives a signal from, for instance, a receive antenna (not shown), and performs typical actions thereon (e.g., filters, amplifies, down converts, etc.) the received signal and digitizes the conditioned signal to obtain samples. Receiver 802 can be a non-linear receiver. A demodulator 804 can demodulate and provide received pilot symbols to a processor 806 for channel estimation. A FLO channel component 810 is provided to process FLO signals. This can include digital stream processing and/or positioning location calculations among other processes. Processor 806 can be a processor dedicated to analyzing information received by receiver 802 and/or generating information for transmission by a transmitter 816, a processor that controls one or more components of user device 800, and/or a processor that both analyzes information received by receiver 802, generates information for transmission by transmitter 816, and controls one or more components of user device 800. A memory may also be provided to facilitate processor execution. It is noted that the device 800 is exemplary in nature and intended to convey general functionality. With respect to forward link only (FLO) functionality, the FLO stream can co-exist with a wireless device such as a phone but is essentially independent of normal device transmit and receive operations. Hence, a FLO channel would not employ the transmitter 816.

It will be appreciated that the data store (e.g., memories) components described herein can be either volatile memory or nonvolatile memory, or can include both volatile and nonvolatile memory. By way of illustration, and not limitation, nonvolatile memory can include read only memory (ROM), programmable ROM (PROM), electrically programmable ROM (EPROM), electrically erasable ROM (EEPROM), or flash memory. Volatile memory can include random access memory (RAM), which acts as external cache memory. By way of illustration and not limitation, RAM is available in many forms such as synchronous RAM (SRAM), dynamic RAM (DRAM), synchronous DRAM (SDRAM), double data rate SDRAM (DDR SDRAM), enhanced SDRAM (ESDRAM), Synchlink DRAM (SLDRAM), and direct Rambus RAM (DRRAM). The memory 808 of the subject systems and methods is intended to comprise, without being limited to, these and any other suitable types of memory. User device 800 further comprises a background monitor 814 for processing FLO data, a symbol modulator 814 and a transmitter 816 that transmits the modulated signal.

It is noted that a Forward Link Only (FLO) air interface covers protocols and services corresponding to OS16 having Layers 1 (physical layer) and Layer 2 (Data Link layer). The Data Link layer is further subdivided into two sub-layers, namely, Medium Access (MAC) sub-layer, and Stream sub-layer. Upper Layers can include compression of multimedia content, access control to multimedia, along with content and formatting of control information.

The FLO air interface specification typically does not specify the upper layers to allow for design flexibility in support of various applications and services. These layers are shown to provide context. The Stream Layer includes multiplexes up to three upper layer flows into one logical channel, binding of upper layer packets to streams for each logical channel, and provides packetization and residual error handling functions. Features of the Medium Access Control (MAC) Layer includes controls access to the physical layer, performs the mapping between logical channels and physical channels, multiplexes logical channels for transmission over the physical channel, de-multiplexes logical channels at the mobile device, and/or enforces Quality of Service (QOS) requirements. Features of Physical Layer include providing channel structure for the forward link, and defining frequency, modulation, and encoding requirements.

The FLO physical layer uses a 4K mode (yielding a transform size of 4096 sub-carriers), providing superior mobile performance compared to an 8K mode, while retaining a sufficiently long guard interval that is useful in fairly large SFN cells. Rapid channel acquisition can be achieved through an optimized pilot and interleaver structure design. The interleaving schemes incorporated in the FLO air interface facilitate time diversity. The pilot structure and interleaver designs optimize channel utilization without annoying the user with long acquisition times. Generally, FLO transmitted signals are organized into super frames. Each super frame is comprised of four frames of data, including TDM pilots (Time Division Multiplexed), Overhead Information Symbols (OIS) and frames containing wide-area and local-area data. The TDM pilots are provided to allow for rapid acquisition of the OIS. The OIS describes the location of the data for each media service in the super frame.

Typically, each super frame consists of 200 OFDM symbols per MHz of allocated bandwidth (1200 symbols for 6 MHz), and each symbol contains 7 interlaces of active sub-carriers. Each interlace is uniformly distributed in frequency, so that it achieves the full frequency diversity within the available bandwidth. These interlaces are assigned to logical channels that vary in terms of duration and number of actual interlaces used. This provides flexibility in the time diversity achieved by any given data source. Lower data rate channels can be assigned fewer interlaces to improve time diversity, while higher data rate channels utilize more interlaces to minimize the radio's on-time and reduce power consumption.

The acquisition time for both low and high data rate channels is generally the same. Thus, frequency and time diversity can be maintained without compromising acquisition time. Most often, FLO logical channels are used to carry real-time (live streaming) content at variable rates to obtain statistical multiplexing gains possible with variable rate codecs (Compressor and Decompressor in one). Each logical channel can have different coding rates and modulation to support various reliability and quality of service requirements for different applications. The FLO multiplexing scheme enables device receivers to demodulate the content of the single logical channel it is interested in to minimize power consumption. Mobile devices can demodulate multiple logical channels concurrently to enable video and associated audio to be sent on different channels.

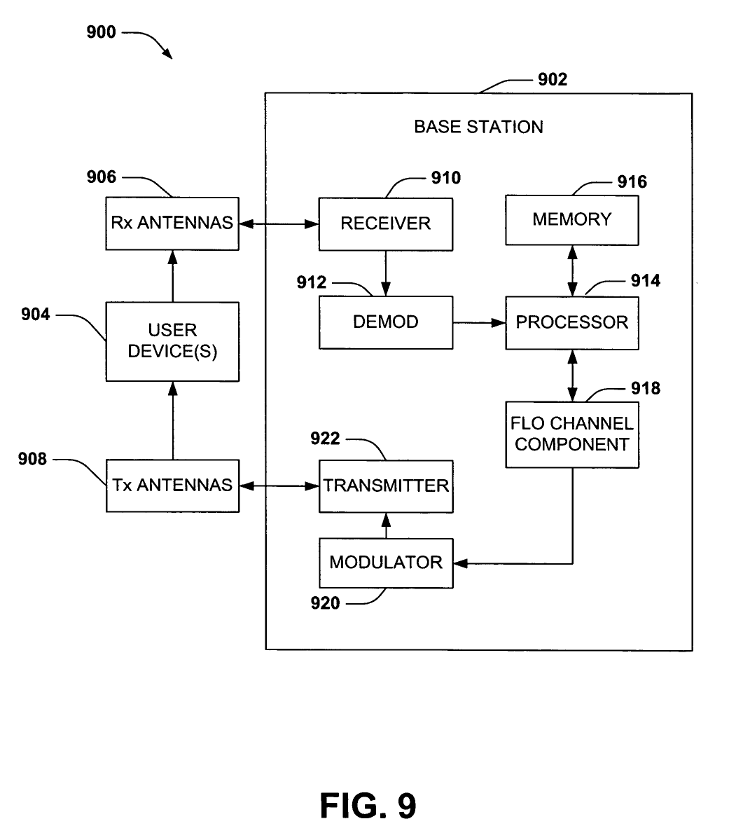

FIG. 9 is an illustrates an example system 900 that comprises a base station 902 with a receiver 910 that receives signal(s) from one or more user devices 904 through a plurality of receive antennas 906, and a transmitter 924 that transmits to the one or more user devices 904 through a transmit antenna 908. Receiver 910 can receive information from receive antennas 906 and is operatively associated with a demodulator 912 that demodulates received information. Demodulated symbols are analyzed by a processor 914 that is similar to the processor, and which is coupled to a memory 916 that stores information related to user ranks, lookup tables related thereto, and/or any other suitable information related to performing the various actions and functions set forth herein. Processor 914 is further coupled to a FLO channel 918 component that facilitates sending FLO information to one or more respective user devices 904. A modulator 922 can multiplex a signal for transmission by a transmitter 924 through transmit antenna 908 to user devices 904.

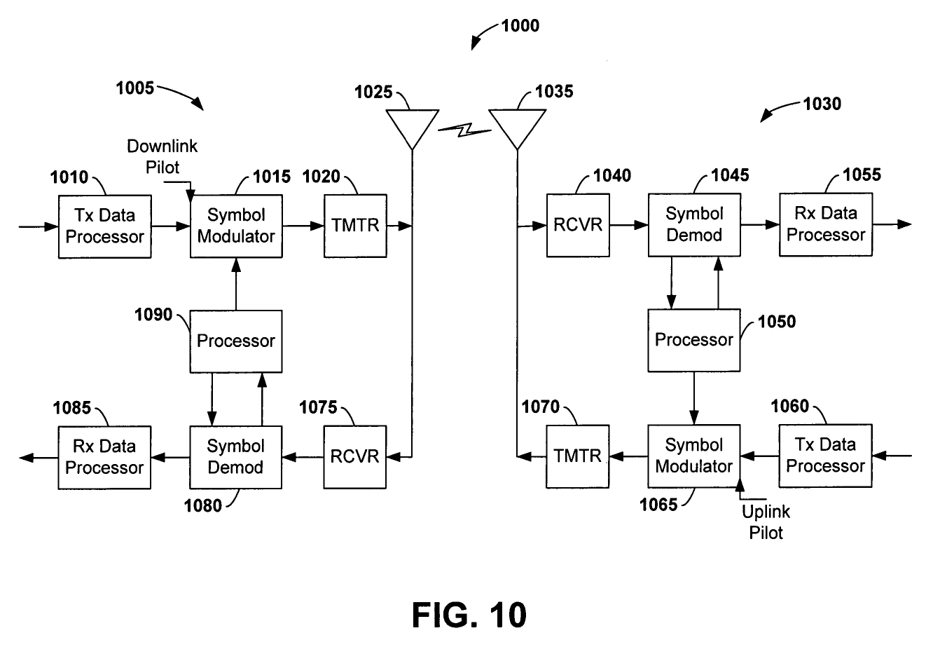

FIG. 10 shows an exemplary wireless communication system 1000. The wireless communication system 1000 depicts one base station and one terminal for sake of brevity. However, it is to be appreciated that the system can include more than one base station and/or more than one terminal, wherein additional base stations and/or terminals can be substantially similar or different for the exemplary base station and terminal described below.

Referring now to FIG. 10, on a downlink, at access point 1005, a transmit (TX) data processor 1010 receives, formats, codes, interleaves, and modulates (or symbol maps) traffic data and provides modulation symbols (“data symbols”). A symbol modulator 1015 receives and processes the data symbols and pilot symbols and provides a stream of symbols. A symbol modulator 1020 multiplexes data and pilot symbols and provides them to a transmitter unit (TMTR) 1020. Each transmit symbol may be a data symbol, a pilot symbol, or a signal value of zero. The pilot symbols may be sent continuously in each symbol period. The pilot symbols can be frequency division multiplexed (FDM), orthogonal frequency division multiplexed (OFDM), time division multiplexed (TDM), frequency division multiplexed (FDM), or code division multiplexed (CDM).

TMTR 1020 receives and converts the stream of symbols into one or more analog signals and further conditions (e.g., amplifies, filters, and frequency up converts) the analog signals to generate a downlink signal suitable for transmission over the wireless channel. The downlink signal is then transmitted through an antenna 1025 to the terminals. At terminal 1030, an antenna 1035 receives the downlink signal and provides a received signal to a receiver unit (RCVR) 1040. Receiver unit 1040 conditions (e.g., filters, amplifies, and frequency down converts) the received signal and digitizes the conditioned signal to obtain samples. A symbol demodulator 1045 demodulates and provides received pilot symbols to a processor 1050 for channel estimation. Symbol demodulator 1045 further receives a frequency response estimate for the downlink from processor 1050, performs data demodulation on the received data symbols to obtain data symbol estimates (which are estimates of the transmitted data symbols), and provides the data symbol estimates to an RX data processor 1055, which demodulates (i.e., symbol de-maps), de-interleaves, and decodes the data symbol estimates to recover the transmitted traffic data. The processing by symbol demodulator 1045 and RX data processor 1055 is complementary to the processing by symbol modulator 1015 and TX data processor 1010, respectively, at access point 1005.

Processors 1090 and 1050 direct (e.g., control, coordinate, manage, etc.) operation at access point 1005 and terminal 1030, respectively. Respective processors 1090 and 1050 can be associated with memory units (not shown) that store program codes and data. Processors 1090 and 1050 can also perform computations to derive frequency and impulse response estimates for the uplink and downlink, respectively.

Systems and devices described herein may be implemented in hardware, software, or a combination thereof. For a hardware implementation, the processing units used for channel estimation may be implemented within one or more application specific integrated circuits (ASICs), digital signal processors (DSPs), digital signal processing devices (DSPDs), programmable logic devices (PLDs), field programmable gate arrays (FPGAs), processors, controllers, micro-controllers, microprocessors, other electronic units designed to perform the functions described herein, or a combination thereof. With software, implementation can be through modules (e.g., procedures, functions, and so on) that perform the functions described herein. The software codes may be stored in memory unit and executed by the processors 1090 and 1050.

For a software implementation, the techniques described herein may be implemented with modules (e.g., procedures, functions, and so on) that perform the functions described herein. The software codes may be stored in memory units and executed by processors. The memory unit may be implemented within the processor or external to the processor, in which case it can be communicatively coupled to the processor via various means as is known in the art.

What has been described above includes exemplary embodiments. It is, of course, not possible to describe every conceivable combination of components or methodologies for purposes of describing the embodiments, but one of ordinary skill in the art may recognize that many further combinations and permutations are possible. Accordingly, these embodiments are intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A method for timing acquisition in a wireless network, comprising:
filtering a correlation output of a TDM pilot via a correlation function; and
employing the correlation output to determine a frequency in a wireless network.

2. The method of claim 1, further comprising employing an edge template for the correlation function.

3. The method of claim of claim 1, further comprising determining timing information from the correlation function.

4. The method of claim 1, further comprising processing a superframe to determine the correlation output.

5. The method of claim 4, the superframe is transmitted in an Orthogonal Frequency Division Multiplexing (OFDM) network.

6. The method of claim 4, the superframe is transmitted as part of a forward link only (FLO) broadcast.

7. The method of claim 1, further comprising generating a ramp output signal for the correlator output.

8. The method of claim 7, further comprising combining the ramp output signal with a correlation function in a filter.

9. The method of claim 8, further comprising measuring output from the filter via a peak detector component.

10. The method of claim 8, further comprising measuring output from the filter via at least one threshold.

11. The method of claim 10, the threshold is adjustable.

12. The method of claim 8, further comprising applying output from the filter to at least one other correlation component.

13. The method of claim 8, further comprising applying a differentiation between a delayed correlator output and a correlation function.

14. The method of claim 8, further comprising employing a subset of samples from a delayed correlator output to determine a peak output.

15. A correlator module for a wireless network, comprising:
a time division correlator that processes a superframe field to determine a delayed correlator output;
a correlation function to be processed with the delayed correlator output; and
a filter that combines the delayed correlator output and the correlation function to determine a start point for the superframe.

16. The module of claim 15, further comprising an edge template that matches a front portion of an ideal autocorrelation function for a TDM Pilot 1 symbol.

17. The module of claim 16, a delayed correlator component generates the auto correlation function.

18. The module of claim 16, the edge template is of length T_{E} (-A -A -A . . . -A B B B B . . . B) that matches the front portion of the ideal autocorrelation function.

19. The module of claim 16, further comprising an accumulator that collects data for a frequency accumulation process of an automatic frequency control (AFC) component during a TDM Pilot symbol period.

20. The module of claim 19, further comprising a timer that is employed with the accumulator to facilitate the frequency acquisition process.

21. The module of claim 19, further comprising a component to reset the timer and the accumulator if a larger signal output is detected at a filter output.

22. The module of claim 19, further comprising a component to employ a known parameter of a superframe to determine a stop time for a frequency acquisition.

23. The module of claim 19, further comprising a buffer that is applied to a delayed correlator output with

24. The module of claim of claim 23, further comprising a component that detects when a timer expires and stops a frequency accumulator.

25. The module of claim 19, having a machine readable medium having machine executable instructions stored thereon to execute the time division correlator, the correlation function, or the filter.

26. A component for determining timing or frequency data in a wireless network, comprising:
means for analyzing a superframe to determine a delayed output signal;
means for generating a correlation function; and
means for filtering the delayed output signal and the correlated function to determine a start of an OFDM packet.

27. A machine readable medium having machine executable instructions stored thereon, comprising:
processing an OFDM packet to determine a delayed correlator output signal; and
applying a correlation function to the delayed correlator output signal to determine a start time for an OFDM data packet.

28. The machine readable medium of claim 27, further comprising applying the correlation function and the delayed correlator output signal to a filter.

29. The machine readable medium of claim 28, further comprising determining a frequency estimate from an output of the filter.

30. A machine readable medium having a data structure stored thereon, comprising:
a data field storing delayed correlater values from an OFDM broadcast packet;
a data field to store a correlated function for the OFDM broadcast packet; and
a filter field to determine a start sequence for the OFDM broadcast packet based in part on the delayed correlator values and the correlated function.

31. A wireless communications apparatus, comprising:
a memory that includes a component to determine a delayed time division correlator values from a received OFDM broadcast; and
a processor that determines a start time for the OFDM broadcast by comparing the delayed time division correlator values to a correlated function.

32. A processor that executes instructions for determining timing information for a wireless communication environment, the instructions comprising:
receiving an OFDM broadcast packet;
determining delayed time domain correlations for the OFDM broadcast packet; and
determining a start time synchronization for a wireless receiver based in part on the time domain correlations and at least one correlated function.

33. The processor of claim 32, further comprising instructions that determine frequency information for the wireless receiver.
